(19) United States
(12) Patent Application Publication
(10) Pub. No.: US 2025/0212189 A1
(43) Pub. Date: Jun. 26, 2025

(54) MULTI-AP COORDINATION OF CHANNEL BANDWIDTH ON A PER-STATION BASIS

(71) Applicant: Cisco Technology, Inc., San Jose, CA (US)

(72) Inventors: Malcolm M. SMITH, Richardson, TX (US); Indermeet S. GANDHI, San Jose, CA (US); Brian D. HART, Sunnyvale, CA (US)

(21) Appl. No.: 18/661,167

(22) Filed: May 10, 2024

Related U.S. Application Data
(60) Provisional application No. 63/613,015, filed on Dec. 20, 2023.

(51) Int. Cl. H04W 72/0453; H04L 5/00

(52) U.S. Cl. CPC H04W 72/0453; H04L 5/0007

(57) ABSTRACT

The embodiments herein supplement a coordinated access point (AP) scheme (such as Multi-AP Coordination (MAPC) with C-(O) FDMA) with a protocol that determines sub-channel/resource unit (RU) allocations for each AP in a coordinated group (CG) on a per-station (STA) basis. A group leader for the CG can receive channel information from the STAs (which is forwarded to the group leader from the APs in the CG). Using this information, the group leader can assign RUs to the STAs to divide up the bandwidth of the wireless medium shared by the APs in the CG.

### CROSS-REFERENCE TO RELATED APPLICATIONS

This application claims benefit of co-pending U.S. provisional patent application Ser. No. 63/613,015 filed Dec. 20, 2023. The aforementioned related patent application is herein incorporated by reference in its entirety.

### TECHNICAL FIELD

Embodiments presented in this disclosure generally relate to assigning bandwidth on a per station (STA) basis in a coordinated group containing multiple access points (APs).

### BACKGROUND

Future versions of Wi-Fi will likely include Multi-AP Coordination (MAPC) techniques such as coordinated spatial reuse (C-SR) and coordinated beamforming which are used to improve spectrum efficiency and network capacity by enabling concurrent transmissions across multiple APs. MAPC aims to improve the overall network performance by allowing APs to share time, frequency, and/or spatial resources in a coordinated way, thus alleviating inter-AP contention and enabling new multi-AP channel access strategies.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates reporting data in a coordinated group, according to one embodiment.

FIG. 2 illustrates assigning resource units in a coordinated group, according to one embodiment.

FIG. 3 is a flowchart for assigning resource units in a coordinated group, according to one embodiment.

FIG. 4 is a flowchart reporting data to a group leader and assigning resource units, according to one embodiment.

FIG. 5 depicts an example computing device, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes receiving, at a group leader, channel information for a plurality of access points (APs) and user devices in a coordination group (CG), allocating resource units (RUs) to selected user devices associated with the plurality of APs where the RU allocation divides up bandwidth of a co-channel shared by the plurality of APs in the CG, and transmitting the RU allocations from the group leader to the plurality of APs.

Another embodiment presented in this disclosure is a network device that includes one or more processors and memory configured to store computer readable program code which, when executed by any combination of the one or more processors, performs an operation. The operation includes receiving, at a group leader, channel information for a plurality of access points (APs) and user devices in a coordination group (CG), allocating resource units (RUs) to selected user devices associated with the plurality of APs where the RU allocation divides up bandwidth of a co-channel shared by the plurality of APs in the CG, and transmitting the RU allocation to the plurality of APs.

Another embodiment presented in this disclosure is an access point that includes one or more processors and memory configured to store computer readable program code which, when executed by any combination of the one or more processors, performs an operation. The operation includes receiving channel information from a user device associated with the AP, transmitting, based on the channel information, a report to a group leader of a coordination group (CG) where the AP belongs to the CG, and receiving a resource unit (RU) allocation from the group leader to use to communicate with the user device, where the RU allocation is a portion of bandwidth of a co-channel shared by a plurality of APs in the CG.

### Example Embodiments

Embodiments herein use resource units (RUs) to divide up the wireless medium (e.g., a co-channel) shared by a coordination group (CG) being controlled by a group leader. For example, the CG can use coordinated frequency division multiple access (C-FDMA) or coordinated orthogonal frequency division multiple access (C-OFDMA) where the APs in the CG divide up the wireless medium into frequency resources like subchannels or RUs. The APs can advertise a new channel size to the connected stations (STAs) (e.g., user devices). This prevents inter-basic service set (BSS) collisions. However, there are issues with C-(O) FDMA. For example, C-(O) FDMA divides up the shared channel (e.g., 320 MHz) with static assignments to each AP for a fixed duration (e.g., over a hundred transmit opportunities (TXOPs)). This limits flexibility in taking advantage of opportunistic data traffic variations across STAs. For example, at the beginning of the TXOPs, one AP may get the bulk of the bandwidth (e.g., 300 MHz of the 320 MHz) because it is busy, but by the end of the TXOPs, it may need significantly less while another AP is now busy. C-(O) FDMA does not provide the flexibility to dynamically reassign the subchannels or RUs.

Moreover, C-(O) FDMA cannot change frequency selective channel conditions per STA. If the AP is allocated a sub-channel/RU that leads to poor reliability and PHY data rate backoffs when communicating with its connected STAs, C-(O) FDMA does not have a feedback mechanism to change the allocation so that AP can use a different portion of the shared channel.

Additionally, centrally optimizing sub-channel/RU allocations across coordinated APs is challenging with only local group-level sub-channel/RU allocation knowledge. C-(O) FDMA by itself does not provide high bandwidth (low latency) communications that can be used by a group leader of the CG to determine optimal sub-channel/RU allocations.

The embodiments herein supplement a coordinated AP scheme (such as MAPC with C-(O) FDMA) with a protocol that determines the sub-channel/RU allocations for each AP in the CG on a per-STA basis. One such suitable protocol is subchannel selective transmission (SST). SST (which was introduced in IEEE 802.11ah) provides mechanisms for STAs to report channel properties to an AP. Expanding this to a CG, the APs can collect the SST data from the STAs and transmit it to the group leader. Using the SST data, the group leader can perform sub-channel/RU allocations on a per-STA basis. For example, the SST data can indicate what sub-channels or RU would be suitable for a particular AP/STA combination, thereby avoiding using a sub-channel/RU that results in poor reliability and PHY data rate backoffs.

In addition, SST RUs enable the group leader to divide the bandwidth of the shared channel dynamically. That is, each RU can define a sub-portion of the co-channel that an AP can use to communicate with a particular STA. As the needs of the APs and STAs changes, the group leader can change the allocation of the bandwidth in the channel (e.g., every TXOP). Thus, unlike C-(O) FDMA which relies on allocating channel bandwidth during fixed (lengthy) durations, SST enables the group leader to update the sub-channel/RU allocation in response to changed needs of the APs.

However, the embodiments herein are not limited to SST, as there are other techniques that also permit a group leader to dynamically allocate spectrum on a per-STA basis, such as non-primary channel access (NPCA) and dynamic subchannel operation (DSO).

In this manner, the embodiments herein can improve utilization of allocated spectrum and throughput gain of C-(O) FDMA by allocating RUs on a per-STA basis as part of a CG of APs (e.g., MAPC).

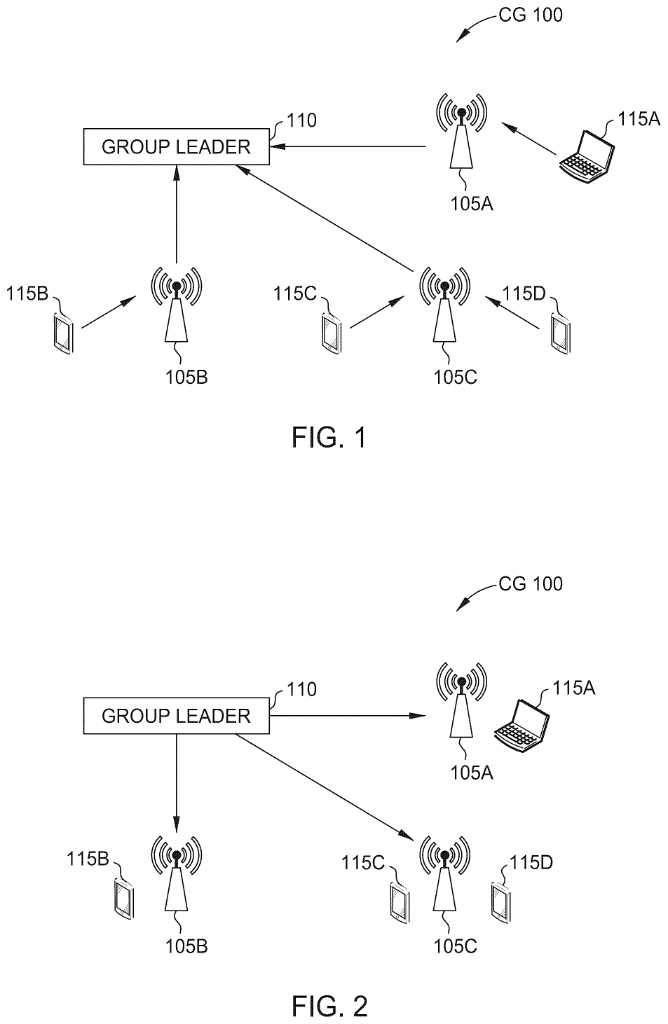

FIG. 1 illustrates reporting SST data in a CG 100, according to one embodiment. While the embodiments below specifically recite using SST to allocate spectrum of a shared channel, other techniques can be used such as NPCA and DSO.

The CG 100 includes a plurality of APs 105A-C which are coordinated by a group leader 110. The CG 100 can also be referred to as a multi-AP group. In one embodiment, the CG 100 uses C-FDMA or C-OFDMA which leverages SST to divide up the wireless medium into frequency resources such as subchannels or RUs on a per-STA basis. For example, the APs 105 may use a shared channel (e.g., a 320 MHz channel) to communicate with STAs 115A-D (e.g., user devices). The bandwidth of the shared channel (also referred to as a co-channel) can be allocated to the APs 105. For example, the group leader 110 can allocate 20 MHz subchannels or RUs of the 320 MHz channel to the APs 105 to use when communicating with the STAs 115. Notably, the 320 MHz of available bandwidth in the co-channel can be allocated in any number of portions. For instance an RU can have a minimum size of 2 MHz and can have a maximum size of 320 MHz (in case one AP 105 is allocated the entire bandwidth in the co-channel).

FDMA is a channel access method used in some multiple-access protocols. FDMA allows multiple users to send data through a single communication channel. When used in a wireless context, C-FDMA permits different APs to use different portions (e.g., subchannels or RUs) of the co-channel. However, as discussed above, C-FDMA (and C-(O) FDMA) has limitations such as having limited flexibility, not considering potentially poor subchannel/RU allocation, and having only local group-level sub-channel/RU allocation knowledge.

SST uses individual target wake time (TWT) to negotiate semi-static service periods during which narrowband STAs switch to non-primary subchannels. SST allows stations to rapidly select and switch to different subchannels between transmissions to counter fading over narrow subchannels. SST was introduced in IEEE 802.11ah and 802.11ax, but IEEE 802.11be introduced support for SST as an important capability of high efficiency (HE) STAs and APs. This allows APs to transmit packets to STAs selectively only on specific subchannel portions of the operating bandwidth. SST provides the ability to opportunistically utilize the spectrum (on a per STA basis) instead of operating on fixed wider channels. Traditionally, SST was used to conserve power. The AP can move STAs to a secondary subchannel (i.e., away from the primary subchannel) for an extended duration. The STAs can only transmit when triggered by the AP.

Some embodiments herein use SST to allocate bandwidth in the CG 100. In these examples, SST is used to assign resources for C-FDMA or C-OFDMA. Part of SST includes reporting channel information from the STAs 115 to the APs 105, which is shown in FIG. 1. As shown by the arrows, each STA 115 can report SST data (also referred to as frequency selective channel reports) to a corresponding AP 105 (i.e., the AP to which the STA has associated with). For example, a sounding protocol can be used to trigger the STAs 115 to measure the channel between the AP 105 and itself and report SST data, which can include a received signal strength indicator (RSSI), a channel quality index, RU resolution, and the like.

The APs 105 can collect and use the SST data received from each STA 115 to derive a report which is then transmitted to the group leader 110. In one embodiment, the APs 105 may compress the data, or send only a portion of the SST data received from the STA 115. In a further embodiment, the AP 105 may capture its own measurements of the channel used to communicate with the STAs 115 and also send this data to the group leader 110.

In one embodiment, the group leader 110 uses the SST data received from the APs 105 to determine which subchannels/RUs to assign to each of the APs to use to communicate with the STAs 115. In one example, the group leader 110 uses the SST data to select which subchannels/RUs an AP can use to communicate with a particular STA that maximizes PHY data rates and reliability. For example, an AP and STA communication path can experience multipath fading which results in frequency selective fading where some subchannels have worse performances than others. However, with the SST data, the group leader 110 can identify which subchannels for a particular AP/STA combination will (or do) experience multipath fading and which do not. The group leader 110 can allocate subchannels/RUs to the AP/STA combination that do not experience multipath fading.

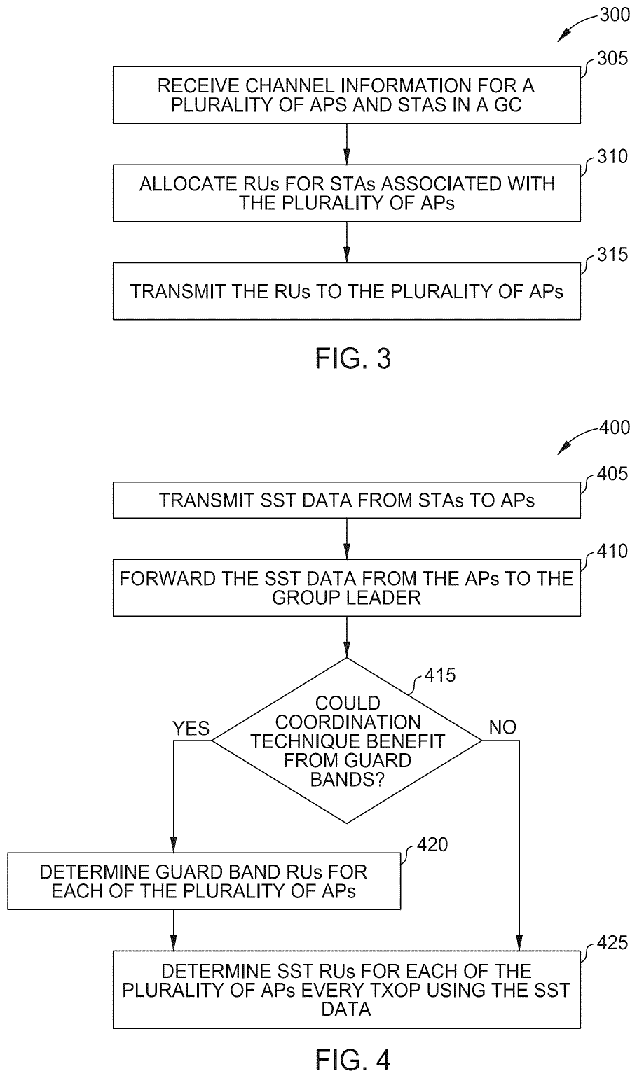

In addition, the reports sent from the APs 105 to the group leader 110 can indicate the current bandwidth needs for the APs 105 in order to communicate with the associated STAs 115. For example, at one point of time, AP 105A can report that it has a lot of data to send to, or receive from, STA 115A while the APs 105B and 105C may report they do not need much bandwidth to communicate with their associates STAs 115B-D. However, at another point of time, the scenario can flip where AP 105 reports it does not have much data to transfer to/from the STA 115A but the APs 105B and 105C do anticipate transmitting or receiving significant amounts of data. With this information, the group leader 110 can assign more subchannels/RUs to the STA 115A associated with AP 105A than to the STAs 115B-D associated with APs 105B and 105C during the first time period but then assign more subchannels/RUs to STAs 115B-D than to STA 115A during the second time period. In this manner, fixed sub-channel/RU allocation as provided by C-(O) FDMA is replaced with dynamic on-demand SST RU allocation. More information regarding allocating the subchannels/RUs is discussed in FIG. 3.

The embodiments herein are not limited to any particular technique for selecting the group leader 110. In one embodiment, the group leader may be a separate computing device (e.g., not an AP). For example, the group leader may be a wireless controller. However, in another embodiment, the group leader 110 may be one of the APs 105 within the CG 100. For example, a system administrator may select the group leader 110 from among the APs 105, or the APs 105 may elect the group leader 110. The group leader 110 can include software or hardware for receiving the reports from the APs 105 (which can include SST data received from the STAS 115) and allocating the subchannels/RUs.

Moreover, the embodiments herein are not limited to use SST, but can include any technique or protocol that gathers channel information (e.g., RSSI, a channel quality index, RU resolution, etc.) from the STAs 115 which can then be relayed to the group leader 110.

In one embodiment, the STAs 115 are user devices (or client devices) such as smartphones, tablets, desktop computers, laptops and the like.

FIG. 2 illustrates assigning SST resource units in a coordinated group, according to one embodiment. In one embodiment, FIG. 2 illustrates a time after FIG. 1 where the group leader 110 receives reports containing SST data from the APs 105 and then uses that data to allocate the spectrum of the co-channel to the STAs 115.

The arrows in FIG. 2 illustrate the group leader 110 transmitting RUs to the APs 105. For ease of reference, these are referred to as SST RUs. While C-(O) FDMA can allocate the spectrum of the co-channel using fixed wider channels, using SST RUs permits the group leader 110 to assign the co-channel on a per STA basis. That is, with C-(O) FDMA, the group leader 110 can assign portions of the co-channel to particular APs—e.g., 100 MHZ (or the first five 20 MHz subchannels) of the 320 MHz co-channel to AP 105A, 100 MHz (or next five 20 MHz subchannels) of the 320 MHz co-channel to AP 105B, and 120 MHz (or the last six 20 MHz subchannels) of the 320 MHz co-channel to AP 105C. The AP can then use those subchannels to communicate with its associated STAs 115 however it sees fit.

However, with SST RUs, the group leader 110 can allocate specific subchannels that can only be used to transmit to a particular STA 115. That is, using SST RUs, the group leader 110 can allocate the spectrum of the co-channel on a per-STA basis rather than a per-AP basis. Further, because the group leader 110 collects the SST data as discussed in FIG. 1, performing SST means the group leader can select SST RUs for each STA to minimize co-channel interference (CCI). This allows APs and STAs to operate on full width channels where the group leader 110 selects a mutually non-interfering subset on a per-TXOP basis (e.g., for every TXOP).

As an example, the SST RUs can indicate that the AP 105A should use 100 MHz of the 320 MHz co-channel to communicate with STA 115A, the AP 105B should use a different 100 MHz of the 320 MHz co-channel to communicate with STA 115B, and the AP 105C should use a different 80 MHz of the 320 MHz co-channel to communicate with STA 115C and the last 40 MHz of the 320 MHz co-channel to communicate with STA 115D.

Moreover, unlike traditional SST where the APs 105 decide SST allocations, here the group leader 110 allocates the SST RUs when considering the bandwidth needs of the CG 100 as a whole. That is, the MAPC CG group leader 110 dynamically allocates SST RUs to the APs 105 in the same C-(O) FDMA TXOPs to time share the co-channel efficiently. In addition, as the bandwidth needs of the CG 100 changes, the group leader 110 can change the allocation of the SST RUs. For example, if the AP 105C wants more bandwidth, the previous allocation from the previous example could change where the group leader 110 provides a new set of SST RUs indicating that the AP 105A should use 80 MHz to communicate with STA 115A, the AP 105B should use a different 80 MHz to communicate with STA 115B, and the AP 105C can use a different 100 MHz to communicate with STA 115C and the last 60 MHz of the 320 MHz co-channel to communicate with STA 115D.

The group leader 110 can also assign the SST RUs based on the arrangement (or interference) of the APs 105 in the physical environment. Rather than making SST assignments using an AP which only knows interference for its STAs, the group leader has knowledge of the interferences for each AP in the CG. For example, the group leader 110 can determine that APs 105A and 105C are in close proximity so that there is interference if they are assigned neighboring subchannels (neighboring RUs) in the channel. However, the AP 105B may be farther away from APs 105A and 105C. In that case, the group leader 110 can assign SST RUs to 105B with subchannels that neighbor subchannels assigned to the STAs associated with AP 105A and 105C. However, the group leader 110 may not assign neighboring subchannels to the STAs associated with APs 105A and 105C (e.g., assigns a disjoint subset of the spectrum to the APs 105A and 105C). For instance, the group leader 110 may assign a portion of the spectrum of co-channel to the STAs of AP 105B that is between the portion of the spectrum assigned to the STAs of AP 105A and the portion of the spectrum assigned to the STAs of AP 105C.

This assignment of the SST RUs by the group leader 110 can also consider which subchannels have good performance (e.g., avoid multipath fading and maximize PHY data rates and reliability) for a particular AP/STA combination and which subchannels yield poor performance.

FIG. 3 is a flowchart of a method 300 for assigning RUs in a CG on a per-STA basis, according to one embodiment. At block 305, the group leader (e.g., the group leader 110 described in FIGS. 1 and 2) receives channel information for a plurality of APs and STAs (e.g., user devices) in the CG such as RSSI, a channel quality index, RU resolution, etc. In one embodiment, this channel information can include the SST data discussed in FIG. 1. As shown in that figure, the APs in the CG can use a sounding protocol to cause the STAs to report the SST data (e.g., RSSI, a channel quality index, RU resolution, and the like) to the APs. The APs can then forward this data to the group leader. However, method 300 is not limited to using SST to collect channel information from the STAs.

In some embodiments, the APs may perform their own analysis on the channel information before relaying it to the group leader. For example, to distribute the compute burden, the APs may evaluate the channel information received from the STAs to provide recommendations to the group leader about which subchannels result in the best performance when communicating with a particular SST. For instance, the APs may rank or categorize the subchannels and provide this information to the group leader. Or the APs may compress the data. However, in other embodiments, the APs may transmit the same (raw) channel information they received from the STAs directly to the group leader. Further, the APs 105 can add additional data that they measured to a report that is then provided to the group leader.

At block 310, the group leader allocates RUs for the STAs (e.g., user devices) associated with the plurality of APs. These RUs indicate a portion of the bandwidth that the APs can use to communicate with a particular STA. For example, if SST RUs are used, the SST RUs indicate a specific subchannel that is the only subchannel the AP can use to communicate with the STA. However, the embodiments herein are not limited to SST RUs and other techniques such as NPCA and DSP can be used to allocate the bandwidth/spectrum of the channel on a per-STA basis.

When allocating the RUs, the group leader can consider the factors discussed above. For example, the group leader can assign the SST RUs according to current bandwidth needs of each AP and STA. For instance, APs that has a lot of data to send or receive to a particular STA can be allocated RUs with larger portions of the bandwidth than STAs that have less bandwidth needs. For example, an AP may want more bandwidth to communicate with a particular STA, but may not need very much bandwidth to communicate with another STA. Since the RUs allocate the bandwidth on a per-STA basis, the group leader can allocate a first RU with more bandwidth to be used to transfer data between the AP and the busy STA and allocate a second RU with less bandwidth to be used to transfer data between the AP and the slower STA.

The group leader can also assign the RUs so the subchannels being assigned to a particular AP/STA combination do not have multipath fading issues. For instance, the group leader can select subchannels with sufficient reliability and that avoid PHY data rate backoffs. The group leader can determine which subchannels to avoid (or which subchannels are particular good) for each AP/STA combination using the channel information received at block 305.

At block 315, the group leader transmits the RUs to the plurality of APs. In one embodiment, the RUs can correspond to the same TXOP for the co-channel.

FIG. 4 is a flowchart of a method 400 for reporting SST data to a group leader and assigning SST RUs, according to one embodiment. At block 405, the STAs transmit SST data to the APs. This can be performed using any of the embodiments discussed above in FIG. 1 and in block 305 of FIG. 3.

At block 410, the APs forward the SST data from the APs to the group leader of the CG. Again, this can be performed using any of the embodiments discussed above in FIG. 1 and in block 305 of FIG. 3.

At block 415, the group leader determines whether the coordination technique could benefit from guard bands. For example, C-FDMA might not establish as strong of a synchronization among the APs as C-OFDMA. In OFDMA, there are two transmitters in adjacent spectrum with reasonable timing and frequency alignment so that a subcarrier in one transmitter is orthogonal to a subcarrier in the other transmitter, which is a stronger synchronization requirement than FDMA. With FDMA, the timing and/or carrier frequencies may not be precisely synchronized which can result in more leakage between subchannels.

As such, if the CG uses C-FDMA then the group leader may decide to use guard bands. However, if C-OFDMA is used, the group leader may not use guard bands. However, C-FDMA is just one example where guard bands may be used. Further, guard bands may also be used in C-OFDMA, but the guard bands may be smaller than if C-FDMA was used.

In any case, if the group leader determines to use guard bands, the method 400 proceeds to block 420 where the group leader determines guard band RUs for each of the plurality of APs. RUs can vary in size. For instance, if a SST RU for 20 MHz is assigned to a first AP and the group leader wants to assign the neighboring 20 MHz to a second AP that is nearby, the group leader can assign a 2 MHz guard band RU to create a guard band (of 2 MHZ) between the 20 MHz subchannel assigned to the first AP and another 20 MHz subchannel assigned to the second AP using a second SST RU. If 2 MHZ is not sufficient, the group leader can assign a larger guard band (e.g., a 20 MHz guard band RU). In this manner, the guard band can be an unused subchannel which separates two neighboring subchannels that are assigned to different APs. Thus, if there is a carrier frequency offset between the APs, the leakage will likely fall into the unused guard band rather than negatively impacting a nearby AP.

At block 425, the group leader determines (and allocates) SST RUs for each of the plurality of APs. This can be performed using any of the embodiments discussed above in FIG. 2 and in block 310 of FIG. 3.

In addition, the group leader can repeat block 425 for every TXOP. That is, rather than allocating the spectrum of the co-channel using a fixed duration (e.g., N number of TXOPs), using SST permits the group leader to change the allocation of the spectrum (e.g., issue new SST RUs) every TXOP. In one embodiment, the group leader can assign RUs to a new set of STAs every TXOP. That is, the group leader can change the allocation of the RUs to the same set of STAs every TXOP or can allocate RUIs to a different set of STAs every TXOP.

However, the group leader may not actually change the SST RUs every TXOP. For example, if the received SST data remains unchanged (or substantially unchanged), the group leader may choose to transmit the same set of SST RUs for the next TXOP. However, as the received SST data changes, the group leader can reallocate the spectrum of the channel by transmitting a new set of SST RUs (where at least one SST RUs changes relative to the SST RUs for the previous TXOP).

In one embodiment, the SST RU allocation can be changed within a frame. For example, at the beginning of the frame, the STAs can be assigned subchannels using a first set of RUs, but at the end of the frame, the group leader may assign those STAs to different subchannels to be in a more convenient location for the next TXOP.

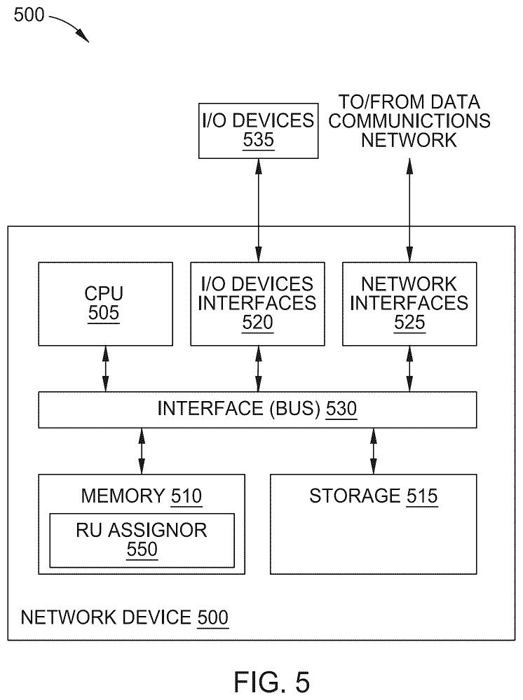

FIG. 5 depicts an example computing device (e.g., a network device 500) configured to perform various aspects of the present disclosure, according to some embodiments of the present disclosure. In some embodiments, the network device 500 corresponds to a group leader, an AP, or a WLC. Although depicted as a physical device, in embodiments, the network device 500 may be implemented using virtual device(s), and/or across a number of devices (e.g., in a cloud environment).

As illustrated, the network device 500 includes a CPU 505, memory 510, storage 515, a network interface 525, and one or more I/O interfaces 520. In the illustrated embodiment, the CPU 505 (e.g., one or more processors) retrieves and executes programming instructions stored in memory 510, as well as stores and retrieves application data residing in storage 515. The CPU 505 is generally representative of a single CPU and/or GPU, multiple CPUs and/or GPUs, a single CPU and/or GPU having multiple processing cores, and the like. The memory 510 is generally included to be representative of a random access memory. Storage 515 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 535 (such as keyboards, monitors, etc.) are connected via the I/O interface(s) 520. Further, via the network interface 525, the network device 500 can be communicatively coupled with one or more other devices and components (e.g., via a network, which may include the Internet, local network(s), and the like). As illustrated, the CPU 505, memory 510, storage 515, network interface(s) 525, and I/O interface(s) 520 are communicatively coupled by one or more buses 530.

In the illustrated embodiment, the memory 510 includes an RU assignor 550, which may perform one or more embodiments discussed above in FIGS. 1-4. For example, the RU assignor 550 may collect the SST data and allocate the SST RUs to the APs in the CG. Although depicted as discrete components for conceptual clarity, in embodiments, the operations of the depicted components (and others not illustrated) may be combined or distributed across any number of components. Further, although depicted as software residing in memory 510, in embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving, at a group leader, channel information for a plurality of access points (APs) and user devices in a coordination group (CG);
allocating resource units (RUs) to selected user devices associated with the plurality of APs, wherein the RU allocation divides up bandwidth of a co-channel shared by the plurality of APs in the CG; and
transmitting the RU allocations from the group leader to the plurality of APs.

2. The method of claim 1, wherein a subset of the RUs defines a sub-portion of the co-channel to be used by one of the plurality of APs to communicate with a specific one or more of the selected user devices.

3. The method of claim 1, further comprising:
determining a new RU allocation for a new set of selected user devices every transmit opportunity (TXOP).

4. The method of claim 1, wherein the RUs are Subchannel Selective Transmission (SST) RUS.

5. The method of claim 1, further comprising:
providing one or more guard bands between the RUs.

6. The method of claim 1, wherein the channel information is derived from reports transmitted by the user devices to the plurality of APs which include frequency selective channel information.

7. The method of claim 1, wherein the CG implements one of coordinated frequency division multiple access (C-FDMA) or coordinated orthogonal frequency division multiple access (C-OFDMA).

8. A network device, comprising:
one or more processors; and
memory configured to store computer readable program code which, when executed by any combination of the one or more processors, performs an operation comprising:
receiving, at a group leader, channel information for a plurality of access points (APs) and user devices in a coordination group (CG);
allocating resource units (RUs) to selected user devices associated with the plurality of APs, wherein the RU allocation divides up bandwidth of a co-channel shared by the plurality of APs in the CG, and
transmitting the RU allocation to the plurality of APs.

9. The network device of claim 8, wherein a subset of the RUs defines a sub-portion of the co-channel to be used by one of the plurality of APs to communicate with a specific one or more of the selected user devices.

10. The network device of claim 8, further comprising:
determining a new RU allocation for a new set of selected user devices every transmit opportunity (TXOP).

11. The network device of claim 8, wherein the RUs are Subchannel Selective Transmission (SST) RUS.

12. The network device of claim 8, wherein the operation further comprises:
providing one or more guard bands between the RUs.

13. The network device of claim 8, wherein the channel information is derived from reports transmitted by the user devices to the plurality of APs which include frequency selective channel information.

14. The network device of claim 8, wherein the CG implements one of coordinated frequency division multiple access (C-FDMA) or coordinated orthogonal frequency division multiple access (C-OFDMA).

15. An access point (AP), comprising:
one or more processors; and
memory configured to store computer readable program code which, when executed by any combination of the one or more processors, performs an operation comprising:
receiving channel information from a user device associated with the AP,
transmitting, based on the channel information, a report to a group leader of a coordination group (CG), wherein the AP belongs to the CG, and
receiving a resource unit (RU) allocation from the group leader to use to communicate with the user device, wherein the RU allocation is a portion of bandwidth of a co-channel shared by a plurality of APs in the CG.

16. The AP of claim 15, wherein the AP can only use the RU allocation to communicate with the user device.

17. The AP of claim 15, wherein the RU is a Subchannel Selective Transmission (SST) RU.

18. The AP of claim 15, wherein the operation further comprises:
receiving a guard band RU from the group leader, wherein a portion of bandwidth defined by the guard band RU neighbors a portion of bandwidth defined by the RU.

19. The AP of claim 15, wherein the channel information received from the user devices includes frequency selective channel information.

20. The AP of claim 15, wherein the CG implements one of coordinated frequency division multiple access (C-FDMA) or coordinated orthogonal frequency division multiple access (C-OFDMA).
